(19) United States
(12) Patent Application Publication
(10) Pub. No.: US 2018/0186574 A1
(43) Pub. Date: Jul. 5, 2018

(54) FOOD PROCESSING TABLE OR CONVEYOR BELT WITH A LAYER OF SOLIDIFIED LIQUID SUCH AS AN ICE LAYER AND METHOD FOR PRODUCING SUCH SOLIDIFIED LIQUID

(71) Applicant: Teknologisk Institut, Taastrup (DK)

(72) Inventor: Jens Teilmann, Taastrup (DK)

(21) Appl. No.: 15/737,363

(22) PCT Filed: Jun. 16, 2016
(86) PCT No.: PCT/EP2016/063862

§ 371 Date: Dec. 18, 2017

(30) Foreign Application Priority Data
Jun. 18, 2015 (DK) PA 2015 00348

(51) Int. Cl. B65G 17/40; A22C 17/00; A22C 21/00; A22C 25/08; A22C 25/06; B65G 17/08; F25C 1/12

(52) U.S. Cl. CPC B65G 17/40; A22C 17/0093; A22C 21/0053; A22C 25/08; A22C 21/0046; B65G 2207/26; B65G 17/083; F25C 1/12; B65G 2201/0211; B65G 2201/0202; A22C 25/06

(57) ABSTRACT

The invention relates to a table or conveyor belt (1) for conveying and/or processing food and a method and system for producing and/or maintaining a layer of a solidified liquid (4) on such tables and conveyor belts (1). Tables or conveyor belts (1) for conveying and processing food are difficult to clean when in function. For food it is important to avoid cross-contamination with microorganisms and foreign objects. A layer of a solidified liquid (4) such as an ice layer or fat layer on the top surface (3) of a table or conveyor belt (1) may be renewed from time to time by planing off some of the solidified liquid (4) and afterwards apply liquid which is allowed to solidify or apply flaked solidified liquid. A conveyor belt (1) may comprise lamellas (2) with internal cavities (7) or channels for coolant to cool the lamellas (2). Solidified liquid (4) may be produced on the top surface (3) of these lamellas (2) and the lamellas (2) may be kept cold by directing a coolant through the lamellas (2).

The present invention relates to food processing table and conveyor belts and to other conveyor belts for conveying items, where the conveyor belts are treated to obtain a layer of solidified liquid such as an ice layer on the conveying part. Such conveyor belts with an ice surface can be used for processing meat e.g. cutting food or such conveyor belts can be used for conveying food such as non-packaged food. The invention also relates to a method for producing and/or maintaining a surface of a solidified liquid such as an ice layer on a processing belt or on a conveyor belt.

### BACKGROUND OF INVENTION

Conveyor belts such as conveyor belts made of a polymeric material may be worn very fast e.g. when used as processing belts in e.g. abbattoirs where employees process carcasses by cutting them into smaller parts while the conveyor belt function as the cutting board. Such conveyor belts can be worn out after only few weeks of work and fragments of the worn conveyor belt may stick to the meat and reduce the quality and price of the products. Usually such fragments may not be present at all in the meat resulting in discard of the meat pieces.

Current conveyor belts used for processing food are difficult to clean, both during a working day where the conveyor belts are used continuously and at the end of a working period when the conveyor belt is stopped. Furthermore small parts from the items being processed such as gristles, bone fragments and trimmings may stick to the belt and be transferred to other food pieces and thereby reducing the quality of the product. The current conveyor belts themselves and the residuals of the items being processed may also increase the risk of cross contaminating with micro-organisms and foreing bodies from contaminated items to non-contaminated items. This should be reduced as much as possible and preferably avoided when processing food.

U.S. Pat. No. 6,837,062 (‘Bacteria resistant butcher table’) describes a bacteria resistant butcher table having a flat level top including a shallow tub within which is placed a butcher block or work surface. Water fills the tub over the top of the work surface insert and is frozen therein. As food preparation proceeds, layers of ice which now constitute the work surface are worn away and replaced by newly frozen water provided from around the sides of the work surface block. A refrigeration system is provided beneath the flat top and has its cooling coils arranged immediately beneath the tub. Water is provided through perforated water piping about the sides of the tub work surface insert.

Other prior art documents exist also describing a butcher table upon which an ice layer is produced, however, none of the documents describe a system comprising lamellas with an inner volume for a coolant or a system for removing or maintaining a solidified layer on a table or on a conveyor belt.

The conveyor belts with a layer of a solidified liquid such as an ice surface as described herein overcome the problems with the current conveyor belts especially when used for processing food. The processing area may be renewed e.g. by removing part of or the entire of the solidified liquid and a new layer may be produced on the surface e.g. before each new round of the conveyor belt is initiated. Fully or partly renewal of the solidified liquid layer prevent growth of micro organisms such as bacteria growth or bacteria ‘build-up’, foreign objects are removed from the belt at least before each new round is initiated, and the processing area will be clean the entire day due to the production of a new layer of solidified liquid such as an ice surface e.g. for each round of the conveyor belt.

Conveyor belts with an ice surface are easy to clean at the end of the day, as it just requires turning off the cooling and the ice will melt.

Using conveyor belts with an ice surface for conveying items may secure cooling of the product during the conveying as during any other processing.

### SUMMARY OF INVENTION

Disclosed is a table or conveyor belt for conveying food or used when processing food e.g. simultaneously with conveying the food. The area of the table or conveyor belt for supporting the food may be treated such that at solidified liquid such as an ice layer is produced on this area before used for supporting the food. The table or conveyor belt may have a surface capable of being cooled e.g. by directing coolant through the table or conveyor belt, or the table or conveyor belt may be with one or more lamellas which can be cooled and become suitable to solidify a liquid applied to the lamellas and keep the solidified liquid on the surface.

A solidified liquid on a table, conveyor belt or lamellas may be ice, fat or oil. The compounds have different properties such as different melting points and may be suitable for different purposes. Ice may be suitable for any food, but requires low temperature to solidify whereas fat such as fat from pigs may be used for conveying and support for processing pigs such as cutting pigs and fats from cows may be used when conveying and processing cattle and cows. Fats from pigs and from cows or cattle have a higher melting point than ice and may therefore be easier to handle.

Lamellas of the conveyor belt may include connecting means capable of connecting the lamellas to each other such that the connected lamellas constitute the conveyor belt and/or the conveyor belt may comprise a support for supporting the lamellas keeping the overall surface of the conveyor belt straight at least in the working areas of the conveyor belt.

The material of the at least one lamella may be any suitable material capable of conducting cold from an inner cold volume to a top surface to cool liquid and solidified liquid on the top surface. The material of the lamella may be a metal such as aluminum or steel and/or the material may be rubber and/or a polymer and/or a combination of polymers and/or fiber composite material such as carbon fibers and glass fibers. In the bottom and/or the edges of the lamellas insulating material may be positioned to direct cold towards the top surface of the lamellas.

Cooling means may be located within the at least one lamella, and cooling means may be at least one inner cavity of lamella and/or at least one channel within each of the lamellas. The cooling means may be for keeping a coolant within the lamellas to keep the lamella cold.

The table, the conveyor belt or the at least one lamella of a table or conveyor belt may comprise cooling connecting means for connecting the cooling means to at least one coolant filling means and/or at least one coolant discharging means for filling and emptying or draining off coolant from the table, conveyor belt or the at least one lamella with coolant.

Disclosed is also a method for producing or maintaining a surface of a solidified liquid on a food processing and/or conveying conveyor belt or on a table or conveyor belt comprising at least one lamella, where the method may comprise the steps of:
a. Optionally plane off solidified liquid such as ice present on the conveyor belt or on the at least one lamella to a first surface thickness and/or removing any solidified liquid present on the conveyor belt or on the at least one lamella,
b. Cooling the table, the conveyor belt or the at least one lamella to obtain a cooled conveyor belt or at least one cooled lamella, where the cooling may be performed by a coolant entered into the conveyor belt or into the at least one lamella before and/or after the table or conveyor belt has been used for conveying and/or processing food,
c. Subjecting the table, the conveyor belt or the at least one cooled lamella to a spray of liquid such as water spray and/or to a vapour such as water vapour to obtain a layer of solidified liquid such as an ice layer on the conveyor belt or on the at least one lamella, preferably the liquid is water or fat suitable for food production, such water may be ground water and/or cleaned water and fat may be fat from an animal or from a plant or subjecting said conveyor belt or
d. said at least one cooled lamella to flaked solidified liquid, pressing said flaked solidified liquid towards the surface of said table, of said at least one lamella or of said conveyor belt to obtain a layer of solidified liquid such as an ice layer on said table, on said conveyor belt or on said at least one lamella,
wherein step a and step b may be performed in any order and only one or both of step c and step d is performed.

Flaked solidified liquid may be flaked fat or flake ice.

The method may further comprise one or more of the steps of:
One or more times level any liquid applied onto the solidified liquid and/or plane off solidified liquid and spray liquid and/or vapour onto solidified liquid on the conveyor belt or on the at least one lamella, or one or more times level and/or plane off said solidified liquid and apply flaked solidified liquid onto said table, onto said conveyor belt (1) or onto said at least one lamella (2), optionally pressing said flaked solidified liquid towards said table, said conveyor belt (1) or towards said at least one lamella (2) and/or
Scratching the solidified liquid such as an ice surface on the conveyor belt or on the at least one lamella at pre-determined distances or scratching the ice surface between the at least one lamella, where the scratches are made crosswise in relation to a running direction of the conveyor belt, and/or
Further cooling or freezing the conveyor belt or the at least one lamella with a solidified liquid on the top surface to obtain a predetermined hardness of the solidified liquid such as an ice surface.

Planing off part of the solidified liquid may be performed as one step prior to applying liquid onto the remaining layer of solidified liquid. This planing off of solidified liquid is preferably performed to remove any micro-organisms and objects which originate from processed food and which should not be transferred to other food items which should be placed on the conveyor belt.

Disclosed is also a system configured to produce a layer of a solidified liquid on a conveyor belt and/or on at least one lamella of a table and/or of a conveyor belt, where the system comprises at least one food conveying and/or processing table or conveyor belt as described elsewhere herein, and
at least one plane to plane off the solidified liquid on the conveyor belt or on the at least one lamella, and
at least one spraying means and/or vaporing means to spray liquid and/or direct vapor onto the conveyor belt or onto the at least one lamella,

the system may further comprise one or more of:
at least one applier for applying flaked solid liquid such as an ice flake applier,
at least one press for pressing flaked solidified liquid such as flake ice towards said table, conveyor belt or towards said at least one lamella,
at least one leveler for levelling non-solidified liquid applied to the conveyor belt or to the at least one lamella or applied onto solidified liquid on the conveyor belt or on the at least one lamella,
at least one hardening/freezing means for cooling and hardening the solidified liquid, where the hardening/freezing means may direct cold towards the conveyor belt or to the at least one lamella and/or towards the solidified liquid of the conveyor belt or of the at least one lamella or the hardening/freezing means may be an area with a cold temperature such as a freezing area surrounding part of a conveyor belt and/or
at least one coolant reservoir for storing and/or cooling coolant used to cool the conveyor belt or the at least one lamella by directing the coolant into the conveyor belt or into the at least one lamella.

Further disclosed is any use of a table or conveyor belt as described herein such as for processing and/or conveying food.

Also disclosed is use of a system as described herein for production and/or maintaining of a layer of a solidified liquid such as an ice surface on a table, on a conveyor belt or on at least one lamella of a table and/or of a conveyor belt where the production and/or maintenance of the layer of solidified liquid may be performed by the method and/or system as described herein.

### BRIEF DESCRIPTION OF FIGURES

FIG. 1 illustrates a conveyor belt (1) with lamellas (2) with a layer of a solidified liquid (4) such as an ice surface.

FIG. 2 illustrates lamellas (2) with a solidified liquid (4) such as an ice layer.

### DETAILED DESCRIPTION OF THE INVENTION

The invention relates to a table and conveyor belt for conveying and/or processing food and where the table or conveyor belt has a surface of a solidified liquid onto which part of a food item may be in contact while being conveyed and/or processed such as when cutting meat.

An aspect of the invention relates to a food conveying and/or processing table or conveyor belt, wherein the table or conveyor belt comprises a top surface made of a material which is a conductor of cold and/or where the top surface is capable of being cooled to a temperature where a liquid or vapor positioned on the surface of the table or conveyor belt solidify.

In an embodiment the table or conveyor belt further comprises at least one lamella with the top surface and optionally the at least one lamella comprises at least one connecting means capable of connecting it to another of the at least one lamella and/or the conveyor belt further comprises a support for supporting the at least one lamella.

The term ‘lamella’ may also be understood as a ‘plate’. When used as or in connection to conveyor belts it is important that the lamellas or plates are suitable to be turned around a roller making the conveyor belt function.

Solidified liquid may be applied onto a conveyor belt as further described herein and scratches or slits may be made in the solidified liquid at different positions of the conveyor belt and crosswise in relation to the running direction of the conveyor belt. Such scratches or slits may secure the conveyor belt is capable of turning around a roller as the solidified liquid will open up where these crosswise scratches or slits are made. The scratches may only be in the upper surface of the solidified liquid hereby the solidified liquid will break beneath these scratches when the conveyor belt turns around a roller. Such a conveyor belt may be made of e.g. rubber, polymers such as plastic, fiber composite material or other materials suitable as a conveyor belt and suitable for solidifying a liquid on the top surface of the conveyor belt.

Scratches may be made by a knife or similar tool which may be guided across the conveyor belt or lamella when scratching in the area where two lamellas meet each other. Scratching may be performed automatic by a scratching means determining the distance to a previous scratch before making a new scratch or identifying the distance between two lamellas to make a new scratch in the solidified liquid above the location where two lamellas meet.

A table is considered to be a working station without a conveyor belt however both a table and a conveyor belt may have any length and width. The length of a table or conveyor belt may be from 50 cm to at least 12 m or even longer.

The term food should be understood as including any animal and/or vegetable item which can be used directly or as an ingredient in the food production, especially in food produced for human consumption, but also in food for animal consumption. Food may thus be raw or processed. Raw food may be carcasses or pieces of carcasses e.g. meat pieces. The carcasses, carcass part or meat pieces may be from any animal, preferably from pigs, cattle, cows, sheep, goats, deer, poultry and fish. Other types of raw food may be vegetables and fruit, such as frozen vegetables or frozen fruit.

Processed food may be any kind of food which can be eaten by humans and/or animals or be included in food which can be eaten by humans and/or animals. Examples of such processed food may be food which should be cut into smaller pieces e.g. sliced cold cuts such as sliced cold meat or pineapples. Processed food may also be bread.

A liquid to solidify on a food processing table or conveyor belt may be any liquid possible to solidify and which is not harmful to the food to be conveyed and/or processed and/or is not harmful to human and/or animal. A liquid to solidify on a table or conveyor belt is preferably water or based on water, or oil or fat or based on oil or fat. Fat may be fat from animal such as from pigs, cattle, cows, sheep, goats, deer, poultry and fish or from plants such as coconut fat. Oil may be vegetable oil. Preferably the liquid to solidify is water or based on water, a fat from an animal or from a plant. More preferably the liquid to solidify is water or based on water. Most preferably the liquid to solidify is water. A solidified liquid may also be produced from flaked solidified liquid applied to and pressed to adhere to a layer of a solidified liquid, thus in the description herein where liquid is described to be applied to a solidified liquid this may be replaced with flaked solidified liquid applied to and pressed onto the solidified liquid.

The invention is mostly described with water and ice as the liquid and solidified liquid, respectively, but it may be any suitable compound and the person skilled in the art would be able to adjust any temperatures given for water and ice into temperatures for other liquids and solidified liquids such as different fats and oils. Fats from different animals such as from pigs and cows may have different melting points, and even fats from the same type of animal may have different melting points. The temperatures indicated herein may be adjusted due to the melting point of a compound to use as a solidified liquid on a table or conveyor belt.

The food processing table or conveyor belt may be a table or conveyor belt comprising at least one lamella with a top surface and where at least the top surface is made of a material which is a conductor of cold and/or where the top surface is capable of being cooled to a temperature where a liquid or vapor positioned on the surface of the lamella solidify.

A layer of solidified liquid such as an ice layer can be produced on the table or conveyor belt. Such a solidified liquid may be used for cooling food and/or as support when handling the food such as when cutting food. A layer of solidified liquid such as an ice layer may obtain a hardness making it suitable for support when food are processed such as when cut e.g. cut into smaller pieces and/or deboned. The handling and/or cutting of the food may be manually or automatic such as by an industrial robot.

The top surface of a lamella is the part of the lamella on which the food is located when conveyed or handled. Preferably a solidified liquid such as an ice layer is only produced on this top layer of the lamellas.

The at least one lamella may be an integrated part of the table or conveyor belt or the at least one lamella may be at least one cassette which is connected to each other and/or to a support before being used on a table or as a conveyor belt. When the solidified liquid should be fully or partly renewed as described further herein e.g. after conveying and/or processing food the at least one cassette may be demounted from the table or conveyor belt and directed to a system for fully or partly renewing the solidified liquid with a method as described herein to obtain lamellas with solidified liquid on the top surface. Such cassettes may comprise a coolant in a cavity or in channels and the cassettes may be cooled or frozen before use on a table or conveyor belt and any replace of a coolant may be avoided during use.

Lamellas of a table or conveyor belt may also stay in position on the table or be part of the conveyor belt while the solidified layer is fully or partly renewed or maintained as further described herein.

The at least one lamella may be connected by at least one connecting means such as at least one hinge and/or the at least one lamella may be connected to a support preferably at the top part of the conveyor belt where the conveyor belt is used for conveying and/or processing. A support may stabilize the conveyor belt to keep it straight and firm preferably when the conveyor belt is a support for processing food.

Each lamella may have at least one hinge suitable to connect it to at least another lamella. A number of lamellas may be connected to constitute a conveyor belt.

A table or conveyor belt with a solidified liquid is preferably for conveying and/or handling/processing of food. Preferably a conveyor belt is for both conveying and handling of food such as when cutting meat at a pace-line at an abattoir or at other food processing companies. A table with a solidified liquid may have a similar function though without the conveying of the food. A conveyor belt as described herein may also be for conveying unpacked food when this is being industrially processed, or for conveying packed food items when these are finally processed and a low temperature of and/or around the food should be obtained.

The length of each lamella, which may corresponds to the width of the table or conveyor belt, may be 10-150 cm, such as between 15-100 cm, e.g. between 20-80 cm. Preferably the length of each lamella is between 20-60 cm, more preferably 35-60 cm especially when the table or conveyor belt is used as support for butchers or operator working with food processing processes. The length of each lamella and/or the width of the table or conveyor belt may be such that only one operator can work in a specific position along the conveyor belt or one operator at each side of the conveyor belt can work in the same position along the conveyor belt.

The width of each lamella may be between 4 mm and 50 cm, such as between 1-50 cm, e.g. 2-30 cm, such as 10-25 cm or 5-50 cm, e.g. 5-30 cm, such as 5-20 cm.

The thickness of each lamella may be 2 mm-10 cm, such as 1-9 cm, e.g. 1.5-8 cm, e.g. 2-7 cm, such as 2.5-6 cm, e.g. 3-5 cm.

In another embodiment the material of the at least one lamella is a metal such as aluminum or steel and/or the material is a rubber and/or polymer such as a fiber composite material.

The material of the top surface and/or of the entire lamellas may be any suitable material. When any food should be in direct contact with the lamella or in direct contact with a solidified liquid on the lamella, the material should preferably be a material suitable for utilize in the production of food. The material is preferably stainless steel. The material may also be a polymer approved for use in food production. When at least the top surface of the at least one lamella is of a polymeric material this polymeric material should preferably be a good conductor of heat and preferably also be durable when subjected to temperatures suitable to solidify a liquid, such as temperatures below 5° C., e.g. below 0° C., such as below −5° C., e.g. below −10° C., such as below −15° C., e.g. below −20° C., where the temperature is dependent on the type of compound to be used as solidified liquid and of its melting point. If coconut butter is used the temperature suitable to solidify liquid coconut butter may be higher e.g. 35° C.

Another embodiment relates to the table or conveyor belt wherein the table or conveyor belt further comprises cooling means within the at least one lamella, and where the cooling means may be at least one inner cavity of each lamella, and/or at least one channel within each lamella, the at least one lamella further comprises a bottom and optionally the bottom further comprises an insulating and/or cold reflecting material directing the cold away from the bottom of the lamella.

Cooling means such as at least one cavity or channel within each lamella may when in use be filled with a coolant suitable for cooling the lamella material.

A lamella may have a top surface of a material suitable for conducting cold from the inner of the lamella to the outer part of the lamella. The lamella may further comprise a bottom and/or edges made of a material which to a lesser extent conducts cold from the inner of the lamella to the outer part of the lamella. The bottom and/or edges of the lamella may also comprise an insulating and/or cold reflecting material directing the cold away from the bottom of the lamella and toward the top surface of the lamella.

The top surface of the conveyor belt or of the at least one lamella may be substantial smooth or it may comprise a pattern in the top surface material such that the top surface may be irregular. Irregular top surfaces of conveyor belt or lamellas may give rise to an improved cooling of the top surface and thus of the solidified liquid produced on the top surface. An irregular top surface may also secure improved adherence of the solidified liquid to the top surface of a conveyor belt or to the at least one lamellas.

A cavity within a lamella may have a size filling substantially the entire inner part of the lamella, hereby the thickness of the lamella material may be 1-10 mm e.g. 1.5-8 mm, such as 2-7 mm, e.g. 2.5-6 mm, such as 3-5 mm and the remaining inner part comprising a cavity.

At least one channel within each lamella may be one channel, e.g. two channels, such as three channels or more. Preferably each channel has a longitudinal direction which is parallel with the top surface of the lamella. Each channel may be straight or curved, e.g. curved with at least one U-turn and preferably both legs in the ‘U’ are parallel to the top surface of the lamella. The at least one channel of a lamella may have openings at least at one edge of the lamella. The at least one channel may be a hose such as a polymeric hose located within the at least one lamella, which may reduce any undesirable effect of a coolant on the material of the at least one lamella. At the openings a channel may have valves suitable to withhold any liquid within the lamella.

The at least one channel of a lamella may have a diameter of at least 2 mm, e.g. at least 3 mm, such as at least 4 mm, e.g. at least 5 mm, such as at least 6 mm, e.g. at least 7 mm, such as at least 8 mm, e.g. at least 9 mm, such as at least 10 mm, e.g. 2-15 mm, e.g. 3-10 mm, such as 4-9 mm, e.g. 5-8 mm, such as 6-7 mm.

An insulating and/or cold reflecting material located in the bottom and/or edges of the at least one lamella may comprise any insulating and/or cold reflecting material such as a polymeric material e.g. polystyrene. The insulating and/or cold reflecting material may be separated from the at least one cavity and/or channel by a heat conducting material such as the material used for the top surface of the lamella.

A further embodiment relates to the table or conveyor belt, wherein the table or conveyor belt further comprises cooling connecting means for connecting the cooling means to at least one coolant filling means and/or at least one coolant discharging means for filling and emptying the at least one lamella with coolant.

Cooling connecting means may be constructed such that when coolant filling means and/or coolant discharging/draining means are not connected to the cooling connecting means the cooling connecting means may include valves securing the coolant remains within the lamella.

Preferably each lamella comprises at least two cooling connecting means which may be at least one suitable for being connected to a coolant filling means and at least one suitable for being connected to a coolant discharging means. Preferably each channel within a lamella is in one end capable of being connected to a coolant filling means and in the other end capable of being connected to a coolant discharging/draining means for fast replacement of coolant

The at least one cooling connecting means may be located at an end of the at least one lamella as indicated in the figures.

The at least one cooling connecting means may also be located in the bottom of the at least one lamella.

Coolant within a lamella may be replaced by connecting coolant filling means and coolant discharging/draining means to the cooling connecting means of a lamella and under pressure fill coolant into the lamella through at least one cooling connecting means and simultaneously remove coolant from at least one other cooling connecting means. The replacing of coolant may be performed while a conveyor belt with at least one lamella is running or while it is not running. Preferably the replacing of coolant is performed while the conveyor belt is running. For each round of a conveyor belt all or some lamellas can have replaced the content of coolant e.g. all lamellas, every second, every third, every fourth or every fifth lamella may be refilled with a cooled coolant.

Two or more cooling connecting means may be positioned at the end and/or at the bottom of each lamellas of a conveyor belt such that the cooling connecting means are positioned at e.g. only one side of the conveyor belt. A robot may connect at least one coolant filling means to the cooling connecting means, obtain cooled coolant from a reservoir and direct it into the lamella through at least one of the cooling connecting means e.g. under pressure and simultaneously remove coolant from the lamella through at least one other cooling connecting means. The robot may follow the conveyor belt while this is running. The robot may connect coolant filling means to at least one lamella at a time, such as to at least two lamellas, e.g. to at least three lamellas, such as to at least four lamellas.

A number of lamellas may be connected such that coolant may be introduced into one lamella and coolant discharged from another lamella when replacing the coolant. Two or more lamellas may be connected such that coolant can be directed from one to another, e.g. three lamellas may be connected, such as four lamellas e.g. five lamellas. A robot replacing the coolant may hereby replace coolant of more than one lamella at a time by directing coolant into one lamella and discharging coolant from another lamella.

Two or more cooling connecting means may also be positioned in the bottom of some or all of the lamellas of a conveyor belt and coolant filling means may be connected to these cooling connecting means when the lamella gets in contact with a roller. The connections through the roller may comprise coolant filling means and coolant discharging means which can be connected to the cooling connecting means of the lamellas. The roller may replace the coolant of all or some of the lamellas with cooled coolant obtained from a coolant reservoir and direct the used coolant to the coolant reservoir or to a cooling means for cooling the coolant. Pressure may be used to enter coolant into the lamella by a positive pressure and/or pressure may be used to remove coolant from the lamella e.g. by vacuum. Preferably when using a brine only a positive pressure is used to press coolant through the at least one lamella to avoid presence of air if a negative pressure is used to aspirate coolant from a lamella. A pressure used when replacing coolant of at least one lamella may be low, e.g. 2-3 bar or preferably up to 10 bar when using brine as the coolant and the pressure may be higher when using e.g. CO₂ for cooling. A roller located in one end of a conveyor belt may replace coolant from e.g. every second lamella while a roller in the other end of the conveyor belt may replace coolant from the other lamellas. Also one roller may replace coolant in every lamellas of a conveyor belt e.g. in each round of the conveyor belt or by replacing coolant in the lamellas e.g. every second time these passes the roller such that for half of the lamellas coolant is replaced in one round of the conveyor belt and for the other half of the lamellas coolant is replaced in the next round of the conveyor belt.

At least one microchip may be located within some or all of the at least one lamella and the microchip may measure the temperature within the lamella and send a signal to a receiver of a robot. The signal may be send only when the temperature of the lamella has increased to a level where the coolant of the lamella should be replaced i.e. a signal is send when the temperature is at or above a pre-determined temperature. One or more signals may also be send independent of the temperature of the lamella and a controller in a robot may determine based on a threshold temperature whether the coolant of the lamella should be renewed.

For a table with at least one lamella cooling connecting means may be located in any suitable location such as at the end of the table and/or at the end of the at least one lamella. Coolant may be replaced frequently by connecting the at least one lamella to a coolant reservoir or the table may be connected to a coolant reservoir continuously.

Coolant may be stored and optionally cooled in a coolant reservoir. Coolant may also be cooled before being stored in a coolant reservoir. Any suitable cooling method may be used, such as cooling by a heat exchanger.

Coolant may be any gas or liquid suitable of being cooled without solidifying and capable of passing cold to other materials to cool the surroundings. Coolant may be an undercooled liquid or gas such as water, brine i.e. water with a salt, glycol, CO₂ etc. CO₂ is less preferred than the other mentioned coolants as CO₂ may impose risk of stunning and death of operators in case of leaking. A brine solution may comprise 10-300 g of salt for each liter of water. With about 300 g/L of salt in water the temperature of the cooled brine may be as low as −20° C. Glycol may be cooled to about −42° C. Water may be cooled to about 0° C. and may be used for cooling conveyor belt or lamellas when using e.g. fat with a melting point above 0° C. as a compound for a solidified liquid. Preferably the coolant does not contaminate the food to be conveyed and/or processed. At the top surface the at least one lamella may comprise furrows in which the liquid may solidify such that part of the solidified liquid is within the furrows.

When in use as described further herein below, a solidified liquid such as an ice layer may be produced on the top surface of each lamella. The thickness of solidified liquid such as ice surface on the lamella may be between 2-100 mm, such as 2.5-50 mm, e.g. 3-40 mm, such as 3.5-30 mm, e.g. 4-20 mm, such as 5-15 mm.

A preferred surface temperature of the solidified liquid is depending on the kind of solidified liquid and the items to be transported and/or processed on the table or conveyor belt. When conveying and/or processing cooled products such as chilled meat of a temperature between 1° C. and 7° C. on a surface of an ice layer the surface temperature of the solidified liquid should preferably be between −1° C. and −7° C., more preferably between −1° C. and −7° C., even more preferably of about −4° C. such as between −3° C. and −5° C.

The surface temperature used when conveying and/or processing products such as meat should preferably be such that the surface does not melt as long as the meat is in contact with the solidified liquid as wet meat preferably should be avoided.

When handling non-chilled meat the surface temperature of an ice layer should preferably be about −2° C. such as between −1° C. and −4° C. depending on how long time meat pieces are in contact with the solidified liquid, the longer contact time the lower surface temperature to avoid melting of the solidified liquid, but not too low a surface temperature to avoid freezing of the meat onto the solidified liquid. Another aspect of the invention relates to a method for producing and/or maintaining a surface of a solidified liquid on a food processing and/or conveying conveyor belt or on a table or conveyor belt comprising at least one lamella, the method comprises the steps of
a. Planing off any solidified liquid such as ice present on the conveyor belt or on the at least one lamella to a first surface thickness and/or removing any solidified liquid present on the conveyor belt or the at least one lamella,
b. Cooling the conveyor belt or the at least one lamella to obtain a cooled conveyor belt or at least one cooled lamella, such as by a coolant entered into the conveyor belt or the at least one lamella before and/or after the table or conveyor belt has been used for conveying and/or processing food,
c. Subjecting the conveyor belt or the at least one cooled lamella to a spray of liquid such as water spray and/or to a vapour such as water vapour to obtain a layer of solidified liquid such as an ice layer on the conveyor belt or the at least one lamella, preferably the liquid is water suitable for food production, such water may be ground water and/or cleaned water,
where step a and step b may be performed in any order.

By ‘plane off’ and ‘planing off’ is meant that a part of the layer of solidified liquid may be planed off or substantially the entire layer of solidified liquid may be planed off.

Preferably only a part of the layer of solidified liquid is planed off to remove any micro-organisms, foreign bodies including splinter of bones and trimmed off fat etc. which may stick to the solidified liquid, the planing off may also remove fully or partly any scratches occurred when knives and other working tools touches the solidified liquid.

In an embodiment the method further comprises one or more of the steps of
d. One or more times level and/or plane off the solidified liquid and spray liquid and/or vapour onto the conveyor belt or onto the at least one lamella,
e. Scratching the solidified liquid such as an ice surface on the conveyor belt or the at least one lamella at pre-determined distances or scratching the ice surface on the conveyor belt or between the at least one lamella, and/or
f. Further cooling or freezing the conveyor belt or the at least one lamellas with a solidified liquid on the top surface to obtain a predetermined hardness of the solidified liquid such as an ice surface.

The central steps of the method are preferably cooling, planing off and applying liquid onto the at least one lamella. Cooling of the at least one lamella may be performed before during and/or after planing off and applying liquid onto the at least one lamella. Cooling may be performed from the inside of the lamellas by a coolant within the lamellas and/or from the outside of the lamellas e.g. by directing cold towards the at least one lamella and/or directing the at least one lamella through an area being cold such as a freezing area. Preferably cooling is performed from the inside of the conveyor belt or of the at least one lamella.

If the at least one lamella of a table or a conveyor belt has a layer of a solidified liquid such as an ice layer on the top surface, this layer may be planed off by a plane to a first thickness or the layer may be removed from the at least one lamella before further solidified liquid is created on the surface of the at least one lamella. The first thickness obtained by a first planing off of the solidified liquid may be determined according to a pre-determined final thickness of a layer of solidified liquid such as an ice layer when the layer should be used such as a support for food conveying and/or support when handling and/or cutting food. A pre-determined final thickness may be a second thickness and the first thickness may be 0.05-2 mm thinner that the second thickness, such as 0.07-1.7 mm, e.g. 0.1-1.5 mm, such as 0.2-1.3 mm, e.g. 0.4-1.1, such as 0.5-1 mm thinner that the second thickness.

A first planing off by a plane is not part of the method when a conveyor belt is started up after having been switched off e.g. due to cleaning, but a first planing off may be included as soon as the conveyor belt is running and a solidified liquid is present on the top surface of the at least one lamella or a first planing off may be included in the method when the solidified liquid has obtained a predetermined thickness e.g. a thickness larger than the first thickness as described herein. To obtain the predetermined thickness at start-up the conveyor belt may be running a number of rounds without being used for conveying food and/or for processing food.

The first surface thickness may be obtained by planing off to eliminate at least any bodies located on and/or sticking to the solidified liquid and any scratches arriving from the processing of items e.g. processing of food, such scratches may be from knives or working tools touching the solidified liquid when handling or cutting food. When planing off to a first surface thickness this may be planing off a layer of between 0.1-3 mm, such as 0.1-2 mm, e.g. 0.2-1.5 mm, such as 0.5-1 mm.

The at least one lamella may be cooled by a coolant directed through the at least one lamella such as through a cavity or through at least one channel of the at least one lamella. The cooling process may be performed before any liquid is directed towards the outside of the at least one lamella such as towards the top surface of the at least one lamella. Coolant may be within the at least one lamella while a conveyor belt is running and at predetermined positions of the conveyor belt any coolant or part hereof within a lamella may be replaced with pre-cooled coolant. In case of a table with a solidified liquid a coolant within the at least one lamella may be replaced at pre-determined intervals such as at pre-determine time-intervals or after performing a pre-determined number of processing steps e.g. when cutting food e.g. the coolant may be replaced each time a cutting of a food piece is finalized.

The at least one lamella is preferably cooled to at temperature such that liquid which is sprayed onto or otherwise directed to the at least one lamella solidify. The temperature of the at least one lamella when water is sprayed onto ice is preferably between −40° C. and 0° C., such as between −30° C. and 0° C., e.g. between −20° C. and 0° C., such as between −10° C. and −1° C., e.g. between −9° C. and −2° C., such as between −8° C. and −3° C., e.g. between −7° C. and −4° C. such as between −6° C. and −5° C., e.g. about −5° C. If the compound to solidify is e.g. beef fat the optimal temperature of the conveyor belt or lamellas may be −8° C. to −7° C. For swine fat the optimal temperature of the conveyor belt or lamellas may be −15° C. to −10° C. For coconut butter the optimal temperature of the conveyor belt or lamellas may be 15° C. to 25° C.

The at least one cooled lamella may be subjected to a spray of liquid such as water spray and/or to a vapour such as water vapour at a temperature such that the spray of liquid and/or vapour solidify on the top surface of the at least one lamella and hereby obtain an ice layer or a layer of solidified liquid on the at least one lamella. Preferably the liquid is water suitable for food production such water may be ground water and/or cleaned water.

Liquid sprayed and or vapourised onto the at least one lamella may have a temperature of between −5° C. and +5° C., such as between −4° C. and +4° C., e.g. between −3° C. and +3° C., such as between −2° C. and +2° C., e.g. between −1° C. and +1° C., such as about 0° C.

After the at least one lamella has been subjected to a spray of liquid the non-solidified liquid on the solidified liquid on the at least one lamella may be levelled to obtain a more even surface of the solidified liquid. Levelling may be avoided if the liquid applied to the conveyor belt or lamellas with or without a solidified liquid does not require to be levelled out.

After the at least one cooled lamella has been subjected to a spray of liquid and this liquid optionally is levelled the at least one lamella may be planed off a second time.

The solidified liquid may be subjected to a number of spraying, levelling and planing off such that the solidified liquid such as an ice layer on the at least one lamella obtains a second surface thickness. The second surface thickness may be a pre-determined thickness of the solidified liquid such as an ice layer which should be obtained before the table or conveyor belt is used for conveying and/or handling food such as for cutting food. The second thickness of the solidified liquid may be 0.5-5 mm, e.g. 0.7-4 mm, such as 1-3 mm, e.g. 1.5-2.5 mm, such as about 2 mm or thicker as described elsewhere herein.

When producing a layer of solidified liquid on at least one lamella of a conveyor belt the solidified liquid between the at least one lamella if any or solidified liquid at edges of the at least lamella may be scratched or cut away such that solidified liquid between the at least one lamella does not hinder the conveyor belt from turning e.g. when turning around a roller. Scratching between the lamellas may be performed when the second surface thickness of the solidified liquid is obtained or after the solidified liquid has been subjected to a further cooling and/or freezing to harden the solidified liquid.

A solidified liquid such as an ice layer on at least one lamella may be further cooled by cooling or freezing the at least one lamellas to obtain a predetermined hardness of the solidified liquid such as of an ice surface. Such a cooling may be performed at a freezing area e.g. at a temperature below −10° C., e.g. below −13° C., such as below −15° C. e.g. below −18° C., such as below −18° C., e.g. below −20° C., such as below −13° C., e.g. below −25° C. Hereby cooling may be performed from outside of the at least one lamella and preferably together with cooling from the inside by coolant being present within the at least one lamella.

The method for producing a solidified liquid such as an ice surface on a food processing table or conveyor belt comprising at least one lamella may be performed in different ways, such that the method when used on a conveyor belt with a solidified liquid on the at least one lamella may after each round of processing food such as cutting food of the conveyor belt comprise the steps of
a. Cooling the at least one lamella to obtain at least one cooled lamella, such as by a coolant entered into the at least one lamella before and/or after the conveyor belt has been used for conveying and/or processing food,
b. Planing off the solidified liquid such as an ice layer on the at least one lamella to a first surface thickness,
c. Subjecting the at least one cooled lamella to a spray of liquid such as water spray and/or to a vapour such as water vapour to obtain an ice layer or a layer of solidified liquid on the at least one lamella, preferably the liquid is water suitable for food production, such water may be ground water and/or cleaned water,
d. One or more times level and/or plane off the solidified liquid and spray liquid and/or vapour onto the at least one lamella, and preferably repeating until the solidified liquid obtain a second surface thickness,
e. Further cooling or freezing the at least one lamellas to obtain a predetermined hardness of the solidified liquid such as an ice surface,
f. Scratching the solidified liquid such as an ice surface on the at least one lamella at pre-determined distances or scratch the solidified liquid between the at least one lamellas, and
g. wherein step e and f can be performed in any order.

For a conveyor belt with an ice layer used as a support for cutting food the method may comprise the steps of
a. Cooling the at least one lamella to obtain at least one cooled lamella, such as by a coolant entered into the at least one lamella before and/or after the conveyor belt has been used for conveying and/or processing food, the coolant may also be replaced when the conveyor belt passes the roller,
b. Planing off the ice layer on the at least one lamella to a first surface thickness,
c. Spraying water onto the ice layer with the first surface thickness,
d. Level the water present on the ice layer,
e. Spraying water onto the ice layer,
f. Level the water present on the ice layer,
g. Cooling the at least one lamellas to obtain a predetermined hardness of the ice surface,
h. Scratching the ice surface between each of the lamellas, and
i. wherein step g and h can be performed in any order, and step e and step f may be repeated until the solidified liquid obtain a second surface thickness.

For a conveyor belt with an ice layer used as a support for cutting food the method may also comprise the steps of
a. Planing off the ice layer on the at least one lamella to a first surface thickness,
b. Spraying water onto the ice layer with the first surface thickness,
c. Levelling the water present on the ice layer,
d. Optionally repeating step b and c one or more times such as 1-9 times,
e. Planing off the ice layer,
f. Spraying water onto the ice layer,
g. Levelling the water present on the ice layer,
h. Repeating step f and g one or more times to obtain a pre-determine second surface thickness of the ice layer,
i. Cooling or freezing the at least one lamellas to obtain a predetermined hardness of the ice surface,
j. Scratching the ice surface between each of the lamellas,
k. Replacing coolant within at least some of the at least one lamella,
l. wherein step i and j can be performed in any order,
and where step k may be performed at any time in the method.

The number of rounds of spraying liquid onto the at least one lamella and levelling the non-solidified liquid both at start-up and after the conveyor belt has been used for conveying and/or processing food may depend on the type of liquid, the temperature, the use of the at least one lamella with a solidified liquid such as type of food to being conveyed and/or cut, the temperature of the surroundings, the length of the table or conveyor belt etc and is preferably determined by tests. A single spraying and levelling may be sufficient although 1-9 rounds of spraying and levelling may be required, such as 1-6 rounds, e.g. 2-4 rounds.

The last one of the steps in the method including planing off, spraying and levelling may be any of the steps. Planing off a very thin layer of the solidified liquid may produce a solidified liquid with a rough surface which may hold on to the food being conveyed and/or processed when compared to a solidified liquid which has been subjected to spraying and/or levelling after planing off solidified liquid. A rough surface may thus be preferred.

The temperature of the solidified liquid and thus of any coolant used to cool the solidified liquid on the at least one lamella may also be determined by tests to obtain an optimal temperature according to the type of conveying and/or processing of food. Preferably the temperature is suitable to avoid the food to stick to or freeze to the solidified liquid such as an ice layer on the at least one lamella. When processing food e.g. by cutting meat the temperature of the food may be below +7° C., such as between 7° C. to −5° C., preferably between 1° C. to 5° C. when cutting the meat by hand and the temperature of the solidified liquid of the at least one lamella may be e.g. −1° C. to −12° C., such as −3° C. to −10° C., e.g. −4° C. to −8° C., such as about −5° C., e.g. about −6° C., such as about −7° C. When conveying and/or processing meat on ice the temperature of the ice should preferably be higher than −8° C., e.g. −1° C. to −7° C., such as −2° C. to −6° C., e.g. −3° C. to −6° C., such as −4° C. to −7° C.

A further aspect of the invention relates to a system configured to produce a layer of a solidified liquid on a conveyor belt and/or on at least one lamella of a table and/or of a conveyor belt, the system comprises at least one food conveying and/or processing table or conveyor belt as further described herein and,
at least one plane to plane off the solidified liquid on the conveyor belt or on the at least one lamella, and
at least one spraying means and/or vapouring means to spray liquid and/or direct vapor onto the conveyor belt or onto the at least one lamella,
optionally the system further comprises one or more of
at least one leveler for levelling non-solidified liquid applied to the conveyor belt or the at least one lamella or applied onto solidified liquid on the conveyor belt or on the at least one lamella,
at least one hardening/freezing means for cooling and hardening the solidified liquid, where the hardening/freezing means may direct cold towards the conveyor belt or the at least one lamella and/or towards the solidified liquid of the conveyor belt or the at least one lamella or the hardening/freezing means may be an area with a cold temperature such as a freezing area surrounding part of a conveyor belt and/or
at least one coolant reservoir for storing and/or cooling coolant used to cool the conveyor belt or the at least one lamella by directing the coolant into the conveyor belt or the at least one lamella.

The at least one plane and the at least one spraying means and/or vapouring means are preferably an integrated part of the food processing system such that a solidified liquid on the at least one lamella can be planed off and maintained with at least a production of a new top layer i.e. maintenance of solidified liquid when the system is used for cutting food.

The system is preferably constructed with at least one plane located before at least one spraying means and/or vapouring means such that when the conveyor belt is running the solidified liquid is first planed off and afterwards liquid or vapour is directed towards the at least one lamella to produce a top layer of solidified liquid such as ice on the at least one lamella. More planes and spraying means and/or vapouring means may be located alternating along the part of the conveyor belt where planing off and production of solidified liquid is performed, such as at the end of the conveyor belt at the upper part of the conveyor belt after an area where the conveyor belt has been used for conveying and/or processing food and before the conveyor belt turns around a roller and/or such as beneath the conveyor belt where the belt is running ‘back’.

The plane may plane off the solidified liquid such as an ice layer present on the at least one lamella to a first thickness of the solidified liquid or it may remove a predetermined thickness of the solidified liquid present on the at least one lamella.

For maintenance of a solidified liquid such as ice the predetermined thickness of the solidified liquid which is removed preferably corresponds at least to the thickness where fragments and/or micro-organisms may be present.

The plane may also remove substantially the entire solidified liquid such as an ice layer present on the at least one lamella.

The plane may have a size making it possible to plane off the entire length of each of the at least one lamella simultaneously. The width of the plane may correspond to the length of the at least one lamella or the width of the plane may be a little wider than the length of the lamellas such as about 5 mm, e.g. about 1 cm, such as about 2 cm.

The at least one spraying means and/or vapouring means may have a size making it possible to easily spray liquid and/or direct vapor onto the entire of the at least one lamella while the conveyor belt is running. The width of the at least one spraying means and/or vapouring means may correspond to the length of the at least one lamella or it may be a little more narrow or a little wider than the lamella length.

For a table with at least one lamella where the at least one lamella is fixed to the table and not moving as a conveyor belt the plane and spraying means and/or vapouring means may be directed across the at least one lamella of the table at a time when a worker changes from handling one item of a food product to handling another item of a food product. The plane and spraying means and/or vapouring means may be initiated by touching a control button such as with a hand and/or with a foot.

A press for pressing flaked solidified liquid such as flake ice towards the table, conveyor belt or towards the at least one lamella may be a hydraulic press or a roller press.

The system for producing and/or maintaining a solidified liquid on a table, a conveyor belt or on at least one lamella may be of items, easy to install in connection to a table optionally comprising at least one lamella or in connection to a conveyor belt optionally comprising at least one lamella.

The items of the system which may be installed in connection to a table or conveyor belt may be selected among the items and be e.g. one or more of planes, spraying means, levelers, appliers for applying flaked solid liquid, presses, and/or hardening/freezing means.

The system may be used only for applying liquid onto the table or conveyor belt, where the table or conveyor belt optionally comprises at least one lamellas, hereby the items of the system may be e.g. one or more planes and spraying means, and optionally one or more levelers and/or hardening/freezing means.

The system may be used only for applying flaked solidified liquid such as ice flakes onto the table or conveyor belt, where the table or conveyor belt optionally comprises at least one lamellas, hereby the items of the system may be e.g. one or more planes, appliers for applying flaked solid liquid, and presses, and optionally hardening/freezing means

The items of the system may be installed in connection to a table with a solidified liquid on the top such as an ice layer or ice block. Frequently such as each time an operator has finished cutting a part of a carcass the system is activated and the at least one plane planes the ice layer or ice block such that preferably any cutting scratches made by the operator and all meat parts are removed from the table, at least one spraying means spray a liquid onto the ice layer or ice block, which then may or may not be leveled by at least one leveler. Planing off the ice layer or ice block and/or applying liquid such as water onto the ice layer or ice block may be performed a number of times such that a preferred thickness of the ice layer or ice block is obtained. Applying liquid onto the ice layer or ice block may be performed more times than planing off the ice layer or ice block. When the pre-determined thickness is obtained the ice layer or ice block may be subjected to a hardening/freezing means to harden the ice layer or ice block.

The items of the system may also be installed in connection to a table with a solidified liquid on the top such as an ice layer or ice block which is treated with flaked solidified liquid such as flaked ice. Frequently such as each time an operator has finished cutting a part of a carcass the system is activated and the at least one plane planes the ice layer or ice block such that preferably any cutting scratches made by the operator and all meat parts are removed from the table, at least one appliers for applying flaked solidified liquid apply flaked solidified liquid such flake ice as onto the ice layer or ice block, which is then pressed onto the ice layer or ice block by at least one presses. Planing off the ice layer or ice block and/or applying flaked solidified liquid such as flake ice onto the ice layer or ice block may be performed a number of times such that a preferred thickness of the ice layer or ice block is obtained. Applying flaked solidified liquid onto the ice layer or ice block may be performed more times than planing off the ice layer or ice block. When the pre-determined thickness is obtained the ice layer or ice block may be subjected to a hardening/freezing means to harden the ice layer or ice block.

The examples of maintaining an ice layer or an ice block on a table may be combined such that liquid can be sprayed onto the ice layer or ice block before or after flaked solidified liquid such as flake ice is applied to the ice layer or ice block.

For conveyor belts optionally comprising at least one lamellas the system may comprise similar items as described in respect of a table i.e. items to produce/maintain a layer of solidified liquid based on spraying liquid onto the conveyor belt or lamellas or applying flaked solidified liquid onto the conveyor belt or lamellas. Also scratching means may be an item of the system especially when connected to a conveyor belt such as a conveyor belt comprising at least one lamellas.

For tables or conveyor belts comprising at least one lamella as described herein the production and/or maintenance of the layer of solidified liquid may be performed when the at least one lamella is located on the table or conveyor belt, however, the at least one lamellas may also be removed from the table or conveyor belt and a layer of a solidified liquid may be produced/maintained in a station for producing and/or maintaining a layer of a solidified liquid on at least one lamellas also renewal of coolant within the at least one lamellas may be performed when the at least one lamella is located on the table or conveyor belt or when the at least one lamella is remove from the table or conveyor belt.

The system may also comprise at least one leveler for levelling non-solidified liquid applied to the at least one lamella or to solidified liquid on the at least one lamella such as liquid sprayed onto the at least one lamella with or without a solidified liquid.

A leveler may have a size making it possible to levelling the entire length of each of the at least one lamella simultaneously. The width of the leveler may correspond to the length of the at least one lamella or the width of the plane may be a little wider than the length of the lamellas such as about 5 mm, e.g. about 1 cm, such as about 2 cm wider. A leveler may also run continuously from side to side of a conveyor belt and level non-solidified liquid in a width of at least 1 cm e.g. at least 5 cm, such as at least 10 cm, e.g. at least 15 cm, such as at least 20 cm.

The system may further comprise at least one slitting means for producing scratches or slits in the solidified liquid crosswise the direction of the running direction of the conveyor belt. The slitting means may comprise a knife and/or other tool which can make a scratch or slit in the solidified liquid. The slitting means may further comprise a distance determining system for determining where in the solidified liquid on a conveyor belt a crosswise scratch or slit should be made. The slitting means may also comprise a means for identifying space between two lamellas and produce a slit in the solidified liquid above this space.

The system may further comprise at least one hardening/freezing means for cooling the at least one lamella onto which liquid spray and/or vapour has been applied to produce and/or enlarge a solidified liquid. The hardening/freezing means may cool the solidified liquid such as an ice layer to give the layer a predetermined hardness making it suitable as support for handling food such as being a cutting board for cutting food on the solidified liquid.

A hardening/freezing means may be a volume surrounding a conveyor belt wherein the temperature is kept cold such that the solidified liquid is further cooled. The hardening/freezing means may be a freezing area such as a freezing tunnel with an entrance and exit for the conveyor belt.

The system may also comprise a coolant reservoir for storing and/or cooling coolant. Coolant discharged from the at least one lamella may be directed to a coolant reservoir for storage and/or cooling until it is used again by feeding it into the at least one lamella. The coolant reservoir may have any size suitable to obtain a sufficient amount of cooled coolant to make it possible to replace coolant of the at least one lamella. The size of the coolant reservoir may correspond to e.g. three to ten times the volume used to fill all the lamellas of a conveyor belt which is in contact with the coolant reservoir. One coolant reservoir may also be a reservoir for more than one conveyor belt requiring a larger volume of the coolant reservoir. A coolant reservoir preferably has a size making it possible to cool the coolant to a temperature which is e.g. 5-20° C., such as 10-15° C. below the temperature of the coolant to be removed from the lamellas.

The system may further comprise at least one edge scratching means to scratch into the solidified liquid such as the ice surface on the belt or to scratch away solidified liquid at the end edge of the lamellas. The edge scratching means should preferably remove any surplus of solidified liquid such as ice produced at the end edges of lamellas such that a conveyor belt with lamellas with solidified liquid on the top surface is capable of running without problems due to too much solidified liquid at the sides of the conveyor belt.

The system may further comprise illuminating means directing light through transparent solidified liquid and/or through the top surface of at least one lamella which may be transparent and/or through the entire lamellas including the solidified liquid which all may be transparent. Illuminating means may be light emitting diodes (LED) e.g. incorporated in the top surface of the at least one lamella. The illuminating means may be present in the table or conveyor belt especially together with templates as described elsewhere herein. Illuminating from below templates may increase the visibility of the template. Illumination from the table or conveyor belt may also be used to create better conditions for the operators as it can be easier to see differences in the food such as location of bones, membranes etc.

When work is stopped and if the conveyor belt should be cleaned as much solidified liquid may be planed off by the plane before the remaining solidified liquid is melted e.g. by turning off the cooling or stop cooling by a coolant. The system used for renewing/replacing coolant in the conveyor belt or the lamellas may also be used for entering warm or hot liquid or warm or hot gas into the lamellas to melt the solidified liquid on top of the lamellas and if necessary the system may be used to renew/replace a warm or hot liquid or gas. Increasing melting of the solidified liquid may also be performed by deliver heat towards the solidified liquid from the outside of the conveyor belt or table with the solidified liquid.

The system may further comprise one or more of:
ironing means for ironing the solidified liquid after planing off solidified liquid and/or after levelling out non-solidified liquid sprayed onto the layer of solidified liquid on a conveyor belt or on at least one lamella,
melting means for melting a non-liquid compound which is used for the production of a solidified liquid, such compounds may be fat,
collecting means for collecting planed off solidified liquid including any bodies being present on the solidified liquid,
containers for storage of collected planed off solidified liquid,
means for removing bodies from the collected solidified liquid e.g. by melting the solidified liquid by a melting means and filtering the bodies from the liquid in a filtering system,
means for cleaning the liquid such as performing sterilization to kill micro-organism in any stage, heat for sterilization may be obtained from a heat exchanger used to cool the coolant,
at least one storage container for storage of cleaned liquid or cleaned non-liquid compound which is used for the production of a solidified liquid, this cleaned liquid or cleaned non-liquid compound may be reused in the production of solidified liquid,
means for location of patterns within the solidified liquid such as colored lines.

Yet another aspect of the invention relates to use of a table or conveyor belt as described herein for processing and/or conveying food.

A conveyor belt as described herein may be used only for conveying food preferably when these are non-packed or un-packed and the temperature of the food should be kept at a pre-determined temperature below e.g. +7° C. A conveyor belt as described herein may also be used for packed food which should be kept cooled or frozen during conveying the food.

Preferably a conveyor belt as described herein may be used for processing food and simultaneously conveying the food from one position to another position. Such positions may be working areas e.g. in a pace-line although one or more positions may be with automatic handling of the food and one or more positions may be with manually handling of the food. Preferably the conveyor belt as described herein is a cutting conveyor where the solidified liquid is used as cutting boards e.g. the conveyor belt is a pace-line for e.g. pigs, cattle, cows, sheep, goats, deer, poultry and fish. Another preferred use of the conveyor belt described herein is for peeling bulk ware before slicing the food.

A table as described herein may be used for cutting food such as when cutting carcasses or part of carcasses of e.g. pigs, cattle, cows, sheep, deer etc. The cutting process at a table is preferably a manual cutting process but automatic tools and/or semi-automatic tools may be used in this cutting process.

Some or all of the at least one lamella may have a template at the top surface of the lamellas e.g. integrated within the lamellas. The template may be visible through transparent solidified liquid such as ice and the template may be e.g. a cutting template illustrating cutting lines of the food to be processed or marks to illustrate where and/or how a food item should be positioned on the table or conveyor belt. A template may also be a color such as at least one colored line located within the solidified liquid. One or more colored lines within the solidified liquid may be used to illustrate where and/or how a food item should be positioned on the table or conveyor belt. Colored lines may be incorporated in the solidified liquid during the production of the layer of solidified liquid and the lines may be renewed or other colored lines may be produced if needed e.g. if processing different kinds of food items. Different colors may be used to signal different information to the operators at a table or along a conveyor belt.

An aspect of the invention also relates to use of a system as described herein for production of a layer of a solidified liquid such as an ice surface on at least one lamella of a table and/or of a conveyor belt optionally performing the production of a layer of solidified liquid by the method as described herein.

The system as described herein may be used to produce a layer of solidified liquid on at least one lamella of a table and/or of a conveyor belt with the method as further described herein.

### DETAILED DESCRIPTION OF THE FIGURES

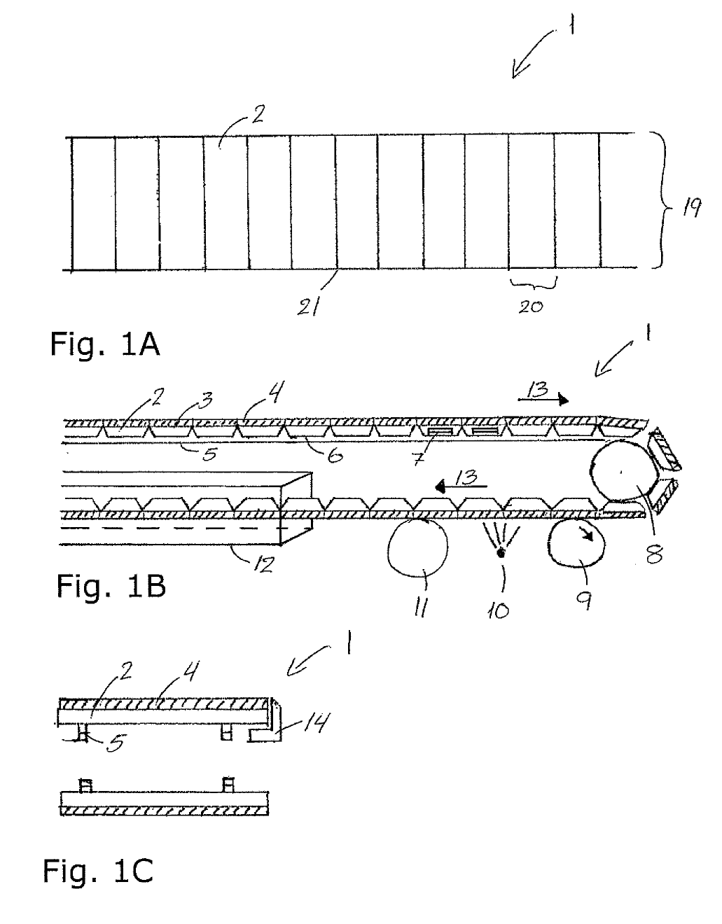

FIG. 1 shows a conveyor belt (1) with a layer of a solidified liquid (4) such as an ice surface and the production of the solidified liquid.

FIG. 1A is a top view of a conveyor belt (1) and may illustrate scratches (21) made in a solidified layer of a conveyor belt without lamellas or may illustrate a conveyor belt made of lamellas (2). The length (19) and width (20) of the lamellas (2) are illustrated together with scratches or slits (21) made in the solidified liquid where two lamellas (2) are neighbors.

FIG. 1B is a side view of a part of a conveyor belt (1) made of lamellas (2). A lamella (2) has a bottom (6) and a top surface (3) and at least one inner cavity or channel (7). The solidified liquid (4) is located at the top surface (3) of a lamella (2) and is indicated as hatched areas. The solidified liquid (4) may include scratches or slits (21) in positions where two lamellas (2) are connected to each other. The lamellas (2) are connected to each other to constitute a conveyor belt (1) or each lamella (2) may be connected to a support (5) keeping the conveyor belt (1) straight. At the end the conveyor belt (1) turns around a roller (8). The conveyor belt (1) is running clockwise as indicated by the arrow (13). A plane (9) planes off the layer of solidified liquid (4) to remove any debris and any scratches in the layer of solidified liquid (4) such as an ice surface. A sprayer (10) sprays liquid such as water onto the top surface (3) of the lamellas (3) or onto the layer of solidified liquid (4) such as an ice surface. A leveler (11) levels any non-solid liquid on the lamellas (2) and in a hardening/freezing means (12) such as a freezing tunnel the layer of solidified liquid (4) such as an ice layer is hardened by freezing. The leveler (11) and/or hardening/freezing means (12) need not be part of the system. Coolant may be replaced from the lamellas at any stage e.g. before and/or after renewal/maintenance of the solidified liquid and/or when a lamella is in contact with a roller (8).

FIG. 1C is a cross section of a conveyor belt (1) with an upper and a lower lamella (2) each with a layer of solidified liquid (4) such as an ice surfaces and at least a support (5) at the upper lamella. An edge protector (14) may protect an operator from being touched by the running conveyor belt (1)

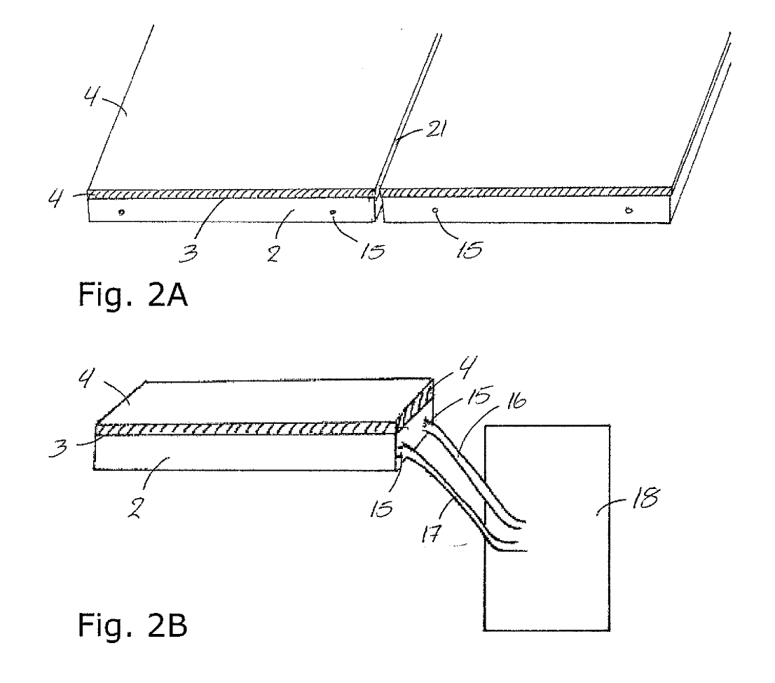

FIG. 2 shows lamellas (2) with a top surface (3) with a layer of solidified liquid (4) such as an ice layer and cooling connecting means (15) at the end.

FIG. 2A shows two lamellas (2) next to each other and which may be part of a conveyor belt (1). Two cooling connecting means (15) are illustrated at the end of each lamella (2). A scratch or slit (21) between the two lamellas (2) is indicated by a space between the lamellas (2) and between the solidified liquid (4) such as ice layers on the lamellas (2).

FIG. 2B shows a lamella (2) with cooling connecting means (15) at the end of the lamella (2) and to which coolant filling means (16) and coolant discharging means (17) are connected. Coolant may be directed into the lamella by the coolant filling means (16) and discharged from the lamella by the coolant discharging means (17). Coolant may be stored in a coolant reservoir (18), where it may be kept cooled before being directed into the lamellas.

### LIST OF ITEMS

1. Conveyor belt
2. Lamella
3. Top surface of lamella
4. Layer of solidified liquid such as an ice layer
5. Support for lamellas
6. Bottom of lamella
7. Inner cavity or channel within lamella
8. Roller
9. Plane
10. Sprayer or vaporizer
11. Leveler
12. Hardening/freezing means such as a freezing tunnel
13. Running direction of conveyor belt
14. Edge protector/cutter
15. Cooling connecting means
16. Coolant filling means
17. Coolant discharging means
18. Coolant reservoir
19. Length of lamella
20. Width of lamella
21. Scratch or slit

1. A conveying apparatus, comprising:
at least one lamella with a top surface made of a material that is a conductor of cold, wherein the top surface is capable of being cooled to a temperature where a liquid or vapor positioned on the top surface of the conveying apparatus or at least one lamella solidifies.

2. The conveying apparatus according to claim 1, wherein the at least one lamella comprises at least one cavity or at least one channel configured to contain a coolant.

3. The conveying apparatus according to claim 1, wherein the at least one lamella comprises at least one lamella connecting means capable of connecting the at least one lamella to another at least one lamella or another conveying apparatus, wherein the conveying apparatus further comprises a support for supporting the another at least one lamella.

4. The conveying apparatus according to claim 2, wherein the material of the at least one lamella is a metal, a rubber, or a polymer, or any combination thereof.

5. The conveying apparatus according to claim 2, wherein the at least one lamella further comprises a bottom with an insulating or cold reflecting material, wherein the insulating or cold reflecting material directs cold away from the bottom of the at least one lamella.

6. The conveying apparatus according to claim 1, further comprising:
a cooling connecting means for connecting a cooling means to at least one coolant filling means or at least one coolant discharging means for filling or emptying the at least one lamella with coolant.

7. A method for producing or maintaining a surface of a solidified liquid on a conveying apparatus comprising at least one lamella, comprising:
planing off solidified liquid present on the conveying apparatus or on the at least one lamella, or both, to a first surface thickness, or removing any solidified liquid present on the conveying apparatus or the at least one lamella;
cooling the conveying apparatus or the at least one lamella to obtain a cooled surface of the conveying apparatus or the at least one lamella, wherein the cooling comprises entering a coolant into the conveying apparatus or the at least one lamella; and
subjecting the conveying apparatus or the at least one lamella to a spray of liquid or to a vapour to obtain a layer of solidified liquid on the conveying apparatus or the at least one lamella; or
subjecting the conveying apparatus or the at least one lamella to a flaked solidified liquid, and pressing the flaked solidified liquid towards the surface of the conveying apparatus or the at least one lamella, or both, to obtain a layer of solidified liquid on the conveying apparatus or the at least one lamella, or both.

8. The method according to claim 7 wherein the liquid comprises ground water or cleaned water.

9. The method according to claim 7, wherein the flaked solidified liquid is flake ice.

10. The method according to claim 7, further comprising one or more of the steps of:
leveling or planning off the solidified liquid at least one time;
spraying liquid or vapour onto the conveying apparatus or the at least one lamella, or both; and
said scratching the solidified liquid on the conveying apparatus or the at least one lamella at pre-determined distances or between the at least one lamella; and
further cooling or freezing the conveying apparatus or the at least one lamella with a solidified liquid on the top surface to obtain a predetermined hardness of the solidified liquid.

11. A system configured to produce a layer of a solidified liquid on a conveying apparatus or at least one lamella, comprising:
the conveying apparatus comprising the at least one lamella with a top surface made of a material that is a conductor of cold, wherein the top surface is capable of being cooled to a temperature where a liquid or vapor positioned on the top surface of the conveying apparatus or the at least one lamella solidifies
at least one plane to plane off the solidified liquid on the conveying apparatus or the at least one lamella; and
at least one spraying means or vapouring means to spray liquid or direct vapor onto the conveying apparatus or the at least one lamella.

12. The system according to claim 11, further comprising one or more of:
at least one press for pressing flaked solidified liquid towards the conveying apparatus or the at least one lamella,
at least one leveler for levelling non-solidified liquid applied to the conveying apparatus or the at least one lamella or applied onto solidified liquid on the conveying apparatus or the at least one lamella,
at least one hardening/freezing means for cooling and hardening the solidified liquid, wherein the hardening/freezing means is configured to direct cold towards the conveying apparatus or the at least one lamella, or the solidified liquid of the conveying apparatus or the solidified liquid at least one lamella; and
at least one coolant reservoir for storing and/or cooling coolant used to cool the conveying apparatus or the at least one lamella by directing the coolant into the conveying apparatus or the at least one lamella.

13. The system according to claim 11, wherein the conveying apparatus is used for processing or conveying food.

14. The system according to claim 13, wherein the food is selected from any animal including parts of pigs, cattle, cows, sheep, goats, deer, poultry and fish, or the food is vegetables or fruit.

15. The system according to claim 11, wherein the system is used for production or maintenance of a layer of a solidified liquid the conveying apparatus or on the at least one lamella.

16. The conveying apparatus according to claim 4, wherein the metal comprises aluminum or steel.

17. The method according to claim 7, further comprising one or more of the steps of:
leveling or planing off the solidified liquid at least one time;
applying flaked solidified liquid onto the conveying apparatus or the at least one lamella; and
pressing the flaked solidified liquid towards the conveying apparatus or the at least one lamella;
scratching the solidified liquid on the conveying apparatus or the at least one lamella at pre-determined distances or scratching the solidified liquid between the at least one lamella; and
further cooling or freezing the conveying apparatus or the at least one lamella with a solidified liquid on the top surface to obtain a predetermined hardness of the solidified liquid.

18. The system according to claim 11, wherein the conveying apparatus further comprises:
at least one cavity or at least one channel configured to contain a coolant.

19. The system according to claim 11, wherein the conveying apparatus further comprises:
at least one lamella connecting means capable of connecting the at least one lamella to another at least one lamella or another conveying apparatus, wherein the conveying apparatus further comprises a support for supporting the another at least one lamella.

20. The system according to claim 12, wherein the hardening/freezing means is a freezing area surrounding part of the conveying apparatus.
